(19) United States
(12) Patent Application Publication
(10) Pub. No.: US 2023/0343929 A1
(43) Pub. Date: Oct. 26, 2023

(54) COMPOSITE POSITIVE ELECTRODE MATERIAL, PREPARATION METHOD THEREFOR, AND APPLICATION IN ZINC ION BATTERY

(71) Applicants: INSTITUTE OF PROCESS ENGINEERING, CHINESE ACADEMY OF SCIENCES, Beijing (CN); LANGFANG TECHNOLOGICAL SERVICE CENTER OF GREEN INDUSTRY, Hebei (CN)

(72) Inventors: Qiangqiang TAN, Hebei (CN); Yuxing XU, Hebei (CN)

(21) Appl. No.: 17/918,623

(22) PCT Filed: Feb. 22, 2021
(86) PCT No.: PCT/CN2021/077186

§ 371 Date: Oct. 13, 2022

(30) Foreign Application Priority Data
May 11, 2020 (CN) 202010392946.2

(51) Int. Cl. H01M 4/36; H01M 4/583; H01M 4/58; H01M 4/04; H01M 10/36

(52) U.S. Cl. CPC H01M 4/364; H01M 4/583; H01M 4/5815; H01M 4/0471; H01M 10/36; H01M 2004/028

(57) ABSTRACT

Disclosed herein are a composite positive electrode material, a preparation method therefor, and an application in a zinc ion battery. The composite positive electrode material comprises: a sulfur-doped three-dimensional network structure conductive polymer/graphene/carbon nanotube composite carbon material, and vanadium tetrasulfide nanoparticles that are loaded on the surface of the composite carbon material; said surface comprises at least one among the outer surface of conductive polymer particles, the sheet-layer surface and interlayer of graphene, and the outer surface of carbon nanotubes.

### TECHNICAL FIELD

The present application relates to the technical field of zinc-ion batteries, and relates to a composite positive electrode material, a preparation method therefor, and an application in a zinc-ion battery.

### BACKGROUND

With the rapid improvement of science and technology as well as the human living standards, the electronic technology has been developed rapidly, and various civilian electronic equipment become more and more popular. The development of electronic devices such as display devices, health monitors, electronic sensors, and electronic skins has received increasing attention from academia and industry. One of the biggest challenges in the development of electronic devices is to develop the corresponding portable energy storage devices that are light, thin and safe, which undoubtedly poses a severe problem for the development of batteries, especially the development of lithium-ion batteries. It has become more attractive to develop novel, safer and cheaper energy storage systems.

In recent years, secondary aqueous zinc-ion batteries have great application prospects in energy storage devices due to their advantages such as high safety, easy assembly, high capacity, low cost, environmental friendliness, and abundant zinc resources. Secondary aqueous zinc-ion batteries adopt neutral or faintly acid electrolyte liquid, the energy storage mechanism of which is a “rocking-chair” battery with Zn²⁺ as a carrier, whereby the reversible storage and release of electrical energy is realized by the dissolution/deposition of Zn²⁺ on the zinc negative electrode and the electrochemical intercalation/deintercalation of Zn²⁺ in the positive electrode. Compared with traditional alkaline Zn batteries, secondary aqueous zinc-ion batteries exhibit excellent rechargeability.

It is well known that rechargeable aqueous batteries are a promising alternative to combustible organic electrolytes, and compared with expensive and flammable traditional lithium batteries, the rechargeable aqueous batteries attract wild attention due to their advantages such as low cost, good safety, and easy assembly. Therefore, the research of secondary aqueous zinc-ion batteries has become a hot research direction in the field of multivalent metal-ion batteries, and has received great progress. However, the development of secondary aqueous zinc-ion batteries still faces a series of scientific and technical difficulties. Firstly, the positive electrode material, as the main component of the secondary aqueous zinc-ion battery, has problems such as low capacity and short lifetime. Secondly, the negative electrode of the secondary aqueous zinc-ion battery has problems such as dendritic crystal growth (especially under high current) and poor reversibility, and the secondary aqueous zinc-ion battery is limited by factors such as water splitting, which leaves the battery exposed to problems such as a narrow voltage window. Additionally, the positive electrode material of the aqueous zinc-ion battery has insufficient electronic conductivity and poor ion-diffusion performance, resulting in a low energy storage capacity. Therefore, it is an urgent problem to be solved to develop a high-performance zinc-ion battery positive electrode material.

In the existing research, CN108400392A discloses a rechargeable flexible zinc-ion battery and a preparation method thereof, including a positive electrode film, an electrolyte film and a negative electrode film stacked in sequence, and the positive electrode film is a conductive polymer/cellulose paper/graphite nanosheet composite material, the negative electrode film is composed of a conductive carbon material film and zinc electroplated on its surface, and the electrolyte film is a gel material prepared from an aqueous solution of cellulose nanofibers and soluble salts. The obtained zinc-ion battery has high flexibility and bending stability, and can be applied to wearable electronic devices, artificial intelligence or other fields. CN109980205A discloses a vanadium pentoxide/graphene composite material for zinc-ion batteries, a preparation method therefor and an application thereof, and the vanadium pentoxide-graphene composite material includes graphene with a three-dimensional conductive network structure, and vanadium pentoxide loaded on the the surface and inside of graphene; when used as a positive electrode material for zinc ion batteries, the composite material has a specific capacity of higher than 200 mAh/g and good cycle performance. However, the electrical conductivity of the composite positive electrode materials prepared by the above two patents is not very ideal.

In summary, the development of a high-performance zinc-ion battery positive electrode material is the key to improving the comprehensive electrochemical performance of zinc-ion batteries.

### SUMMARY

An object of the present application is to provide a composite positive electrode material, a preparation method therefor, and an application in a zinc-ion battery. The present application overcomes the shortcomings of the prior art, and solves the problems of insufficient electrical conductivity, low specific capacity, poor cycle stability and poor rate capability in the existing battery positive electrode materials, and the prepared composite positive electrode material has excellent electrical conductivity, improved battery capacity, enhanced comprehensive electrochemical performance of the battery, and simple preparation process, which possesses very broad development prospects and economic benefits.

In order to achieve the above object, the present application adopts the technical solutions below.

In a first aspect, the present application provides a composite positive electrode material, and the composite positive electrode material includes a sulfur-doped three-dimensional network structure conductive polymer/graphene/carbon nanotube composite carbon material, and trivanadium tetrasulfide nanoparticles loaded on a surface of the composite carbon material;

The surface includes at least one of the outer surface of conductive polymer particles, the surface and the interlayer of graphene sheets, and the outer surface of carbon nanotubes.

In the present application, in the sulfur-doped three-dimensional network structure conductive polymer/graphene/carbon nanotube composite carbon material, sulfur is doped in at least one of the conductive polymer, the graphene and the carbon nanotubes, and optionally, sulfur is doped in all those three.

In the composite positive electrode material of the present application, trivanadium tetrasulfide is loaded on the surface of the composite carbon material, the surface can be at least one of the outer surface of conductive polymer particles, the surface and the interlayer of graphene sheets, and the outer surface of carbon nanotubes, and such structure is conducive to the intercalation and deintercalation of zinc ions as well as electron conduction; the sulfur-doped three-dimensional network structure conductive polymer/graphene/carbon nanotube composite carbon material can provide more active sites for sulfur to be composited (for example, in a way of in situ composite) with tetravanadium trisulfide, which improves the bonding strength between interfaces of the composite carbon material and tetravanadium trisulfide, further improves the electronic conductivity of the composite positive electrode material, and improves the specific capacity of the composite positive electrode material.

The composite positive electrode material of the present application has excellent electronic conductivity and structural stability, and when applied to zinc-ion batteries, it can improve the comprehensive electrochemical performance including specific capacity, rate capability and cycle performance.

The optional technical solutions of the present application are described below, but not intended to limit the technical solutions provided in the present application; by the following optional technical solutions, it can be better to achieve the technical object and beneficial effects of the present application.

Optionally, the trivanadium tetrasulfide nanoparticles are spherical particles.

Optionally, a particle size of the trivanadium tetrasulfide nanoparticles is 100-600 nm, such as 100 nm, 200 nm, 300 nm, 350 nm, 450 nm or 600 nm, optionally 200-400 nm.

Optionally, a mass ratio of the trivanadium tetrasulfide nanoparticles and the composite carbon material is (0.1-30):1, such as 0.1:1, 1:1, 2:1, 5:1, 8:1, 10:1, 13:1, 15:1, 18:1, 22:1 or 30:1, optionally (0.5-25):1, further optionally (0.5-20):1, and especially optionally (1-20):1 excluding 1:1.

Optionally, in the composite carbon material, the carbon nanotubes are aligned carbon nanotubes. In this optional technical solution, the carbon nanotubes are distributed in an ordered form; such aligned carbon nanotubes have highly parallel arrays and can be regarded as one-dimensional quantum wires with excellent electrical conductivity, which has excellent electrical conductivity.

Optionally, in the composite carbon material, a length of carbon nanotubes (CNTs) is 150 nm-10 μm, such as 150 nm, 200 nm, 300 nm, 400 nm, 500 nm, 600 nm, 1 μm, 2 μm, 3 μm, 5 μm or 8 μm; a diameter is less than 15 nm, such as 2 nm, 5 nm, 8 nm, 10 nm, 13 nm or 15 nm. Within this optional range, the specific surface area of carbon nanotubes is large, and the composite positive electrode material can obtain excellent electrochemical performance. For the carbon nanotubes that play an important role in the electrical conductivity of composite positive electrode materials, their electrical conductivity depends on their diameter and helix angle of the tube wall. When the diameter of the CNTs is too large, the electrical conductivity will decrease; when the length of the CNTs is too long, the carbon nanotubes will mixed with the binder and the like in the subsequent application, thus leading to the problems of carbon nanotubes, such as significant agglomeration and uneven dispersion, so that the carbon nanotubes cannot exert its excellent electronic conductivity and effects of improving the electrochemical performance.

Optionally, in the composite carbon material, the graphene includes single-layer graphene and/or multi-layer graphene.

In a second aspect, the present application provides a preparation method for the composite positive electrode material according to the first aspect, and the method includes the following steps:
(1) adding a sulfur powder and a vanadyl acetylacetonate powder into N,N-dimethylformamide, and subjectinge to ultrasonics with stirring, so as to obtain a mixed solution A;
(2) adding a sulfur-doped three-dimensional network structure conductive polymer/graphene/carbon nanotube composite carbon material into the mixed solution obtained in step (1), and continuously subjecting to ultrasonics with stirring, so as to obtain a mixed solution B;
(3) transferring the mixed solution B into a reactor, and subjecting to a solvothermal reaction at 120-200° C., so as to obtain a hydrothermal product; and
(4) subjecting the hydrothermal product to a microwave treatment at 300-800° C. under the protection of an inert atmosphere, so as to obtain the composite positive electrode material.

In the method of the present application, a lower-cost vanadium compound is used as a raw material, and combined with the sulfur-doped three-dimensional network structure conductive polymer/graphene/carbon nanotube composite carbon material, which enables trivanadium tetrasulfide nanoparticles to be composited in situ on the surface or interlayer of those constituting the three-dimensional network structure, including conductive polymer particles, graphene and carbon nanotubes, by ultrasonic chemistry, solvothermal and microwave treatment;

the obtained composite positive electrode material has an extremely stable structure, which solves the problem that positive electrode materials is prone to being dissolved in the electrolyte liquid and has structural instability during the charge and discharge process; additionally, the composite positive electrode material has significantly improved specific capacity and electronic conductivity. The microwave treatment method can furthest protect the three-dimensional nano-network layer structure of the sulfur-doped three-dimensional network structure conductive polymer/graphene/carbon nanotube composite carbon material from being damaged, and protect the coating effect from being affected. The composite positive electrode material prepared in the present application has excellent performances, and for example, has high capacity, good cycle performance and rate capability.

As an optional technical solution of the method in the present application, a mass ratio of the sulfur powder and the vanadyl acetylacetonate powder in step (1) is (0.2-0.8):1, such as 0.2:1, 0.3:1, 0.5:1, 0.6:1 or 0.8:1.

Optionally, a solid content of the mixed solution Ain step (1) is 3-15%, such as 3-15%, such as 3%, 8%, 10%, 12% or 15%.

Optionally, an average particle size of the sulfur powder in step (1) is 1-50 μm, such as 1 μm, 3 μm, 10 μm, 15 μm, 20 μm, 25 μm, 30 μm or 45 μm.

Optionally, an average particle size of the vanadyl acetylacetonate powder in step (1) is 0.5-30 such as 1 μm, 3 μm, 10 μm, 15 μm, 18 μm, 23 μm or 27 μm.

Optionally, the solvent in step (1) is N,N-dimethylformamide.

Optionally, in step (1), a stirring rate is 500-1000 r/min, such as 500 r/min, 600 r/min, 650 r/min, 700 r/min, 800 r/min, 900 r/min or 1000 r/min; a power of the ultrasonics is 50-600 W, such as 50 W, 100 W, 200 W, 240 W, 300 W, 400 W, 500 W or 550 W; a time is 8-20 h, such as 8 h, 12 h, 15 h or 20 h.

Optionally, a temperature of the ultrasonics with stirring in step (1) is 55-80° C., such as 55° C., 60° C., 70° C. or 80° C.

As an optional technical solution of the method in the present application, a preparation method for the sulfur-doped three-dimensional network structure conductive polymer/graphene/carbon nanotube composite carbon material in step (2) includes the following steps:
(a) mixing graphene oxide with a surfactant, subjecting to ultrasonic dispersion, then mixing with a reducing agent, and subjecting to a chemical reduction, so as to obtain reduced graphene with micelles formed in the interlayer of graphene;
(b) dispersing the reduced graphene in step (a) in a solvent, subjecting to ultrasonic treatment, adding a conductive polymer monomer, continuously subjecting to ultrasonics, adding an initiator and carbon nanotubes, and subjecting to a polymerization reaction, so as to obtain a composite carbon material; and
(c) mixing the composite carbon material in step (b) with a sulfur source, subjecting to a reaction in a closed condition with 2-5 MPa pressure, and subjecting to a heat treatment under an inert atmosphere to realize in-situ doping, so as to obtain the sulfur-doped three-dimensional network structure conductive polymer/graphene/carbon nanotube composite carbon material.

Optionally, the surfactant in step (a) includes any one or a mixture of at least two of cetyltrimethylammonium bromide, cetyltrimethylammonium chloride, sodium dodecyl sulfate or sodium dodecylbenzenesulfonate.

Optionally, a mass ratio of the graphene oxide and the reducing agent in step (a) is 10:(6-10), such as 10:6, 10:7.5, 10:8, 10:9 or 10:10.

Optionally, the chemical reduction in step (a) is performed in a water bath at 75-95° C., and the temperature of the water bath is, for example, 75° C., 80° C., 85° C., 90° C. or 95° C.

Optionally, a power of the ultrasonics in step (a) is 50-600 W, such as 50 W, 100 W, 200 W, 300 W, 400 W, 450 W or 550 W.

Optionally, the reducing agent in step (a) includes any one or a combination of two of sodium borohydride or hydrazine hydrate, optionally hydrazine hydrate.

Optionally, the solvent in step (b) includes any one or a mixture of at least two of ethanol, deionized water, inorganic protonic acid or a chloroform solution of ferric chloride.

Optionally, a power of the ultrasonics in step (b) is 80-500 W, such as 80 W, 100 W, 130 W, 200 W, 300 W, 400 W or 500 W.

Optionally, a time of the continued ultrasonics in step (b) is 0.5-2 h, such as 0.5 h, 1 h, 1.5 h, or 2 h.

Optionally, the initiator in step (b) is ammonium persulfate.

Optionally, a molar ratio of the polymer monomer and the surfactant in step (b) is (4-6):1, such as 4:1, 4.5:1, 5:1 or 6:1.

Optionally, a mass ratio of the polymer monomer and the initiator in step (b) is 1:(1-1.5), such as 1:1, 1.2:1 or 1.5:1.

Optionally, the polymerization reaction in step (b) is performed in an ice-water bath.

Optionally, a stirring is performed during the polymerization reaction in step (b), and a rate of the stirring is 500-3000 r/min, such as 500 r/min, 600 r/min, 800 r/min, 1000 r/min, 1500 r/min, 1800 r/min, 2000 r/min, 2500 r/min or 2750 r/min.

Optionally, a time of the polymerization reaction in step (b) is 12-30 h, such as 12 h, 15 h, 20 h, 24 h or 26 h.

Optionally, the carbon nanotubes in step (b) are aligned carbon nanotubes, optionally hydroxylated aligned carbon nanotubes, and further optionally hydroxylated aligned multi-walled carbon nanotubes.

Optionally, the sulfur source in step (c) is selected from any one or a combination of at least two of sodium sulfide, sodium thiosulfate, thiourea, thiol, thiophenol, thioether, disulfide, polysulfide, cyclic sulfide, diallyl sulfide, diallyl thiosulfonate, diallyl trisulfide or diallyl disulfide.

Optionally, the sulfur source in step (c) is thiourea, or a combination of thiourea and at least one of thiol, thiophenol, thioether, disulfide, polysulfide, cyclic sulfide, diallyl sulfide, diallyl thiosulfonate, diallyl trisulfide or diallyl disulfide.

Optionally, based on a mass of the composite carbon material in step (c) being 100%, a mass percentage of the sulfur source is 0.1-5%, such as 0.1%, 0.5%, 1%, 2%, 3% or 4%, optionally 0.1-3%, and further optionally 0.5-2%.

Optionally, a temperature of the reaction in step (c) is 130-280° C., such as 130° C., 150° C., 180° C., 200° C., 240° C. or 260° C., optionally 150-260° C., and further optionally 180-230° C.

Optionally, a time of the reaction in step (c) is 1-24 h, such as 1 h, 3 h, 6 h, 10 h, 12 h, 15 h, 18 h, 20 h or 22 h, optionally 2-16 h.

Optionally, the inert atmosphere in step (c) includes any one or a combination of the two of an argon atmosphere or a nitrogen atmosphere.

Optionally, a temperature of the heat treatment in step (c) is 500-1000° C., such as 500° C., 600° C., 700° C., 800° C., 900° C. or 1000° C., optionally 600-950° C., and further optionally 650-900° C.

Optionally, a time of the heat treatment in step (c) is 0.5-12 h, such as 0.5 h, 1 h, 2 h, 5 h, 8 h or 10 h, optionally 1-8 h.

Optionally, the preparation method for the sulfur-doped three-dimensional network structure conductive polymer/graphene/carbon nanotube composite carbon material further includes steps of cooling, washing and drying after the reaction is completed but before the heat treatment.

Optionally, the washing adopts deionized water, and a number of times of the washing is selected from 3-5 times.

Optionally, the drying is vacuum drying.

Optionally, a temperature of the drying is 60-100° C., such as 60° C., 80° C., 90° C. or 100° C.

Optionally, a time of the drying is 8-20 h, such as 8 h, 10 h, 12 h, 15 h or 18 h, optionally 10-16 h.

The present application has no limitation on the preparation method for aligned carbon nanotubes; for example, aligned carbon nanotubes can be grown in situ on nitrogen-doped ordered mesoporous carbon (publication number of the invention patent: CN106876729B); aligned carbon nanotubes can be prepared by applying a parallel magnetic field along the growth direction of carbon nanotubes in the carbon nanotube growth area during the preparation process of carbon nanotubes (publication number of the invention patent: CN107128901A); aligned carbon nanotubes can be prepared by using a porous silica template (1. Preparation of the ultra-long/open aligned carbon nanotube array [J]. Science In China (Series A), 1999, 29(8): 743; 2. Direct growth of aligned open carbon nanotubes by chemical vapor deposition [J]. Chemical Physics Letters, 1999, 299: 97.); filtration method (Aligned carbon nanotube films: production and optical and electronic properties [J]. Science, 1995, 268(5212): 845.); magnetron sputtering method and sol-gel method (1. Growth of vertically aligned carbon nanotubes on glass substrate at 450° C. through the thermal chemical vapor deposition method [J]. Diamond & Related Materials, 2009, 18: 307; 2. Large-scale synthesis of aligned carbon nanotubes [J]. Science, 1996, 274 (5293): 1701.); floating catalyst method (Study on semi-continuous preparation of carbon nanotube by floating catalyst method. New Carbon Materials, 2000, 15(1): 48.), etc.

The present application has no limitation on the preparation method for hydroxylated aligned carbon nanotubes; for example, aligned carbon nanotubes can be hydroxylated by using an acidizing treatment, and those skilled in the art can refer to the existing technology for preparation; for example, the aligned multi-walled carbon nanotubes are uniformly mixed in a mixed acid of concentrated sulfuric acid and concentrated nitric acid (V (concentrated sulfuric acid):V (concentrated nitric acid)=3:1), subjected to ultrasonics at room temperature for 30 min, then transferred to a three-necked flask, stirred and subjected to the acidizing treatment at 60° C. for 3 h. After cooling to room temperature, the system is diluted with distilled water, and filtered under vacuum, and the filter residue is diluted with distilled water, filtered under vacuum, washed several times until neutral, and the product is dried under vacuum at 80° C. for 24 h, so as to obtain the hydroxylated aligned multi-walled carbon nanotubes.

As an optional technical solution of the method in the present application, a time for the continuously subjecting to ultrasonics with stirring in step (2) is 0.5-2 h, such as 0.5 h, 0.6 h, 1 h, 1.5 h or 2 h.

Optionally, a temperature of the solvothermal reaction in step (3) is 120-200° C., such as 120° C., 150° C., 165° C., 175° C., 185° C. or 200° C.

Optionally, a time of the solvothermal reaction in step (3) is 1-6 h, such as 1 h, 2 h, 3 h, 4 h or 5 h.

Optionally, the method further includes steps of cooling, washing and drying after the solvothermal reaction but before calcining.

Optionally, the washing is a washing with anhydrous ethanol, and the drying is optionally vacuum drying at 50-70° C. (for example, 55° C., 60° C. or 65° C., etc.).

Optionally, a temperature of the microwave treatment in step (4) is 350-700° C., such as 350° C., 400° C., 450° C., 550° C., 600° C. or 650° C., optionally 400-600° C.

Optionally, a time of the microwave treatment in step (4) is 1-5 h, such as 1 h, 2 h, 3 h, 4 h or 5 h, optionally 1.5-4 h.

As a further optional technical solution of the method in the present application, the method includes the following steps:
(1) adding a surfactant into a graphene oxide dispersion with a concentration of 1-1.5 mg/ml, fully dispersing the surfactant by ultrasonics, and then adding hydrazine hydrate, wherein the surfactant forms micelles in the interlayer of graphene during the process that graphene oxide is reduced by hydrazine hydrate, and centrifuging the product to remove excess surfactant, so as to obtain reduced graphene with micelles formed in the interlayer of graphene;
(2) dispersing the centrifuged product in step (1) in a solvent, subjecting to ultrasonic treatment, then adding a conductive polymer monomer, continuously subjecting to ultrasonics for 30-60 min, adding ammonium persulfate and hydroxylated carbon nanotubes, and stirring in an ice-water bath with a rate of 500-3000 r/min for 18-24 h for a polymerization reaction;
(3) centrifuging the product in step (2) and then drying the product under vacuum at 60-70° C., so as to obtain a polymer/graphene/carbon nanotube composite carbon material with a three-dimensional nano-network structure;
(4) mixing the composite carbon material in step (3) with a sulfur source uniformly, subjecting to a reaction in a closed condition with 2-5 MPa pressure, and subjecting the obtained product to a heat treatment under an inert atmosphere to realize in-situ doping, so as to obtain the sulfur-doped three-dimensional network structure conductive polymer/graphene/carbon nanotube composite carbon material;
(5) adding a sulfur powder and a vanadyl acetylacetonate powder into N,N-dimethylformamide, subjecting to rapid stirring and ultrasonics at 55-80° C. for 8-20 h, so as to obtain a mixed solution A with a solid content of 3-15%;
(6) adding the composite carbon material obtained in step (4) into the mixed solution A, continuously stirring and subjecting to ultrasonics for 0.5-2 h, so as to obtain a mixed solution B;
(7) transferring the mixed solution B into a reactor, subjecting to a solvothermal reaction at 120-200° C. for 1-6 h, cooling naturally, then washing with anhydrous ethanol, and fully drying under vacuum at 50-70° C., so as to obtain a product; and
(8) calcining the product obtained in step (7) at 300-800° C. for 1-6 h under the protection of an inert atmosphere, so as to obtain the composite positive electrode material.

In a third aspect, the present application provides an application of the composite positive electrode material according to the first aspect in a zinc-ion battery, in which the composite positive electrode material is used as a positive electrode material for a zinc-ion battery. In a fourth aspect, the present application provides a zinc-ion battery, and the zinc-ion battery includes the zinc-ion battery positive electrode material according to the third aspect.

Optionally, the zinc-ion battery is an aqueous or organic rechargeable zinc-ion battery.

The present application also provides a preparation method for a zinc-ion battery, in which the composite positive electrode material according to the first aspect is used as a positive electrode of the zinc-ion battery, a zinc powder, a zinc foil or a zinc-based alloy is used as a negative electrode, an aqueous solution of zinc sulfate is used as an electrolyte liquid, and glass fiber separator is used as a separator.

Exemplarily, a zinc-ion battery positive electrode is prepared as follows:

the composite positive electrode material according to the first aspect, binder PVDF, and acetylene black are mixed uniformly in a mass ratio of 80:10:10, prepared into a paste with water, then uniformly coated on a titanium foil, and dried in a vacuum oven at 80° C. for 12 h.

Compared with the prior art, the present application has the following beneficial effects:
(1) In the composite positive electrode material of the present application, trivanadium tetrasulfide is loaded on the surface of the sulfur-doped three-dimensional network structure conductive polymer/graphene/carbon nanotube composite carbon material, the surface can be at least one of the outer surface of conductive polymer particles, the surface and the interlayer of graphene sheets, and the outer surface of carbon nanotubes, and such structure is conducive to the intercalation and deintercalation of zinc ions as well as electron conduction; the sulfur-doped three-dimensional network structure conductive polymer/graphene/carbon nanotube composite carbon material can provide more active sites for sulfur to be composited (for example, in a way of in situ composite) with tetravanadium trisulfide, which improves the bonding strength between interfaces of the composite carbon material and tetravanadium trisulfide, further improves the electronic conductivity of the composite positive electrode material, and improves the specific capacity of the composite positive electrode material.
(2) In the method of the present application, a lower-cost vanadium compound is used as a raw material, and combined with the sulfur-doped three-dimensional network structure conductive polymer/graphene/carbon nanotube composite carbon material, which enables trivanadium tetrasulfide nanoparticles to be composited in situ on the surface or interlayer of those constituting the three-dimensional network structure, including conductive polymer particles, graphene and carbon nanotubes, by ultrasonic chemistry, solvothermal and microwave treatment; the obtained composite positive electrode material has an extremely stable structure, which solves the problem that positive electrode materials is prone to being dissolved in the electrolyte liquid and has structural instability during the charge and discharge process; additionally, the composite positive electrode material has significantly improved specific capacity and electronic conductivity. The prepared composite positive electrode material has excellent performances, and for example, has high capacity, good cycle performance and rate capability.
(3) In the present application, the carbon nanotubes can be selected and combined with methods of ultrasonic chemistry, solvothermal and microwave treatment, which can keep the aligned structure of carbon nanotubes better, so that the composite positive electrode material has excellent electrochemical performance.
(4) The present application provides the composite positive electrode material for a zinc-ion battery; in the voltage range of 0.1-0.8 V, and with the current density of 300 mA/g, the initial discharge specific capacity is more than 210 mAh/g, and after 50 cycles, the battery still has a specific capacity of more than or equal to 203 mAh/g and a capacity retention rate of more than or equal to 96.6%; after 150 cycles, the battery still has a specific capacity of more than or equal to 196 mAh/g and a capacity retention rate of more than or equal to 93.3%, and has good electronic conductivity, cycle performance and rate capability.

In summary, the composite positive electrode material in the present application has higher electrical conductivity, higher specific capacity and good cycle stability, and is an ideal positive electrode material for zinc-ion batteries, which can be widely used in various portable electronic devices, wearable electronic equipment, new energy vehicles, aerospace and other fields.

### DETAILED DESCRIPTION

The technical solutions of the present application will be further described below through specific embodiments.

### Example 1

This example provides a composite positive electrode material, and the composite positive electrode material includes a sulfur-doped three-dimensional network structure conductive polymer/graphene/carbon nanotube composite carbon material, and trivanadium tetrasulfide nanoparticles loaded on a surface of the composite carbon material; the surface includes at least one of the outer surface of conductive polymer particles, the surface and the interlayer of graphene sheets, and the outer surface of carbon nanotubes; a mass ratio of the trivanadium tetrasulfide and the composite carbon material is 5:1, and the carbon nanotubes has a length of 300 nm and a diameter of 10 nm.

A preparation method for the composite positive electrode material includes the steps below.
(1) Preparation of a sulfur-doped three-dimensional network structure conductive polymer/graphene/carbon nanotube composite carbon material
a) An appropriate amount of cetyltrimethylammonium bromide was added into a graphene oxide dispersion with a concentration of 1 mg/ml, and fully dispersed by ultrasonics, then hydrazine hydrate was added, and the product was centrifuged to remove excess surfactant, so as to obtain reduced graphene with micelles formed in the interlayer of graphene.
b) The reduced graphene was dispersed in deionized water, subjected to ultrasonic treatment at 100 W, then added with a pyrrole monomer, continuously subjected to ultrasonics for 30 min, added with ammonium persulfate and hydroxylated aligned multi-walled carbon nanotubes, and stirred in an ice-water bath for 24 h for a polymerization reaction, and the product was centrifuged and then dried under vacuum at 60° C. to obtain a black powder, namely, a polymer/graphene/carbon nanotube composite carbon material with a three-dimensional nano-network structure.
c) The composite carbon material and thiourea were mixed uniformly with a mass ratio of 100:5, reacted at 280° C. in a closed condition with 5 MPa pressure for 24 h, cooled naturally, washed 5 times in deionized water, and dried at 100° C. for 8 h, and the obtained product was subjected to a heat treatment at 1000° C. for 0.5 h under an argon atmosphere, so as to obtain the sulfur-doped three-dimensional network structure conductive polymer/graphene/carbon nanotube composite carbon material.

In the steps, a mass ratio of graphene oxide and cetyltrimethylammonium bromide was 1:1, a mass ratio of graphene oxide and hydrazine hydrate was 10:6, a mass ratio of the pyrrole monomer and cetyltrimethylammonium bromide was 4:1, and a molar ratio of the pyrrole monomer and ammonium persulfate was 1:1.
(2) Preparation of a composite positive electrode material
d) A sulfur powder and a vanadyl acetylacetonate powder were added into N,N-dimethylformamide (DMF), in which a mass ratio of the sulfur powder and the vanadyl acetylacetonate powder was 0.2:1, and the mixture was subjected to ultrasonics with stirring at 80° C. for 8 h, in which a stirring rate was 500 r/min and a ultrasonic power was 100 W, so as to obtain a mixed solution A with a solid content of 15%.
e) The sulfur-doped three-dimensional network structure conductive polymer/graphene/carbon nanotube composite carbon material obtained in step (1) was added into the mixed solution A, and continuously subjected to ultrasonics with stirring for 2 h, so as to obtain a mixed solution B.
f) The mixed solution B was transferred to a reactor, subjected to a solvothermal reaction at 200° C. for 1 h, cooled naturally, then washed in anhydrous ethanol, and fully dried under vacuum at 70° C., so as to obtain the product, and the product was subjected to microwave at 600° C. for 4 h under the protection of an argon atmosphere, so as to obtain the composite positive electrode material.

### Example 2

This example provides a composite positive electrode material, and the composite positive electrode material includes a sulfur-doped three-dimensional network structure conductive polymer/graphene/carbon nanotube composite carbon material, and trivanadium tetrasulfide nanoparticles loaded on a surface of the composite carbon material; the surface includes at least one of the outer surface of conductive polymer particles, the surface and the interlayer of graphene sheets, and the outer surface of carbon nanotubes; a mass ratio of the trivanadium tetrasulfide and the composite carbon material is 10:1, and the carbon nanotubes has a length of 500 nm and a diameter of 8 nm.

A preparation method for the composite positive electrode material includes the steps below.
(1) Preparation of a sulfur-doped three-dimensional network structure conductive polymer/graphene/carbon nanotube composite carbon material
a) An appropriate amount of sodium dodecylbenzenesulfonate was added into a graphene oxide dispersion with a concentration of 1.2 mg/ml, and fully dispersed by ultrasonics, then hydrazine hydrate was added, and the product was centrifuged to remove excess surfactant, so as to obtain reduced graphene with micelles formed in the interlayer of graphene.
b) The reduced graphene was dispersed in deionized water, subjected to ultrasonic treatment at 80 W, then added with a pyrrole monomer, continuously subjected to ultrasonics for 45 min, added with ammonium persulfate and hydroxylated aligned multi-walled carbon nanotubes, and stirred in an ice-water bath for 18 h for a polymerization reaction, and the product was centrifuged and then dried under vacuum at 80° C. to obtain a black powder, namely, a polymer/graphene/carbon nanotube composite carbon material with a three-dimensional nano-network structure.
c) The composite carbon material and thiourea were mixed uniformly with a mass ratio of 100:0.5, reacted at 150° C. in a closed condition with 3 MPa pressure for 6 h, cooled naturally, washed 4 times in deionized water, and dried at 70° C. for 12 h, and the obtained product was subjected to a heat treatment at 800° C. for 5 h under an argon atmosphere, so as to obtain the sulfur-doped three-dimensional network structure conductive polymer/graphene/carbon nanotube composite carbon material.

In the steps, a mass ratio of graphene oxide and sodium dodecylbenzenesulfonate was 1:0.5, a mass ratio of graphene oxide and hydrazine hydrate was 10:10, a mass ratio of the pyrrole monomer and sodium dodecylbenzenesulfonate was 5:1, and a molar ratio of the pyrrole monomer and ammonium persulfate was 1:1.5.
(2) Preparation of a composite positive electrode material
d) A sulfur powder and a vanadyl acetylacetonate powder were added into N,N-dimethylformamide (DMF), in which a mass ratio of the sulfur powder and the vanadyl acetylacetonate powder was 0.5:1, and the mixture was subjected to ultrasonics with stirring at 60° C. for 16 h, in which a stirring rate was 700 r/min and a ultrasonic power was 300 W, so as to obtain a mixed solution A with a solid content of 10%.
e) The sulfur-doped three-dimensional network structure conductive polymer/graphene/carbon nanotube composite carbon material obtained in step (1) was added into the mixed solution A, and continuously subjected to ultrasonics with stirring for 0.5 h, so as to obtain a mixed solution B.
f) The mixed solution B was transferred to a reactor, subjected to a solvothermal reaction at 150° C. for 3 h, cooled naturally, then washed in anhydrous ethanol, and fully dried under vacuum at 60° C., so as to obtain the product, and the product was subjected to calcination at 650° C. for 2 h under the protection of an argon atmosphere, so as to obtain the composite positive electrode material.

### Example 3

This example provides a composite positive electrode material, and the composite positive electrode material includes a sulfur-doped three-dimensional network structure conductive polymer/graphene/carbon nanotube composite carbon material, and trivanadium tetrasulfide nanoparticles loaded on a surface of the composite carbon material; the surface includes at least one of the outer surface of conductive polymer particles, the surface and the interlayer of graphene sheets, and the outer surface of carbon nanotubes; a mass ratio of the trivanadium tetrasulfide and the composite carbon material is 2:1, and the carbon nanotubes has a length of 600 nm and a diameter of 12 nm.

A preparation method for the composite positive electrode material includes the steps below.
(1) Preparation of a sulfur-doped three-dimensional network structure conductive polymer/graphene/carbon nanotube composite carbon material
a) An appropriate amount of cetyltrimethylammonium bromide was added into a graphene oxide dispersion with a concentration of 1.5 mg/ml, and fully dispersed by ultrasonics, then sodium borohydride was added, and the product was centrifuged to remove excess surfactant, so as to obtain reduced graphene with micelles formed in the interlayer of graphene.
b) The reduced graphene was dispersed in deionized water, subjected to ultrasonic treatment at 200 W, then added with a pyrrole monomer, continuously subjected to ultrasonics for 40 min, added with ammonium persulfate and hydroxylated aligned multi-walled carbon nanotubes, and stirred in an ice-water bath for 20 h for a polymerization reaction, and the product was centrifuged and then dried under vacuum at 65° C. to obtain a black powder, namely, a polymer/graphene/carbon nanotube composite carbon material with a three-dimensional nano-network structure.
c) The composite carbon material and thiol were mixed uniformly with a mass ratio of 100:3, reacted at 230° C. in a closed condition with 4.5 MPa pressure for 12 h, cooled naturally, washed 3 times in deionized water, and dried at 80° C. for 6 h, and the obtained product was subjected to a heat treatment at 775° C. for 6 h under an argon atmosphere, so as to obtain the sulfur-doped three-dimensional network structure conductive polymer/graphene/carbon nanotube composite carbon material.

In the steps, a mass ratio of graphene oxide and cetyltrimethylammonium bromide was 1:0.8, a mass ratio of graphene oxide and sodium borohydride was 10:8, a mass ratio of the pyrrole monomer and cetyltrimethylammonium bromide was 6:1, and a molar ratio of the pyrrole monomer and ammonium persulfate was 1:1.5.
(2) Preparation of a composite positive electrode material
d) A sulfur powder and a vanadyl acetylacetonate powder were added into N,N-dimethylformamide (DMF), in which a mass ratio of the sulfur powder and the vanadyl acetylacetonate powder was 0.7:1, and the mixture was subjected to ultrasonics with stirring at 70° C. for 12 h, in which a stirring rate was 800 r/min and a ultrasonic power was 400 W, so as to obtain a mixed solution A with a solid content of 12%.
e) The sulfur-doped three-dimensional network structure conductive polymer/graphene/carbon nanotube composite carbon material obtained in step (1) was added into the mixed solution A, and continuously subjected to ultrasonics with stirring for 1.5 h, so as to obtain a mixed solution B.
f) The mixed solution B was transferred to a reactor, subjected to a solvothermal reaction at 180° C. for 4 h, cooled naturally, then washed in anhydrous ethanol, and fully dried under vacuum at 55° C., so as to obtain the product, and the product was subjected to microwave at 500° C. for 5 h under the protection of an argon atmosphere, so as to obtain the composite positive electrode material.

### Example 4

This example provides a composite positive electrode material, and the composite positive electrode material includes a sulfur-doped three-dimensional network structure conductive polymer/graphene/carbon nanotube composite carbon material, and trivanadium tetrasulfide nanoparticles loaded on a surface of the composite carbon material; the surface includes at least one of the outer surface of conductive polymer particles, the surface and the interlayer of graphene sheets, and the outer surface of carbon nanotubes; a mass ratio of the trivanadium tetrasulfide and the composite carbon material is 0.5:1, and the carbon nanotubes has a length of 10 μm and a diameter of 4 nm.

A preparation method for the composite positive electrode material includes the steps below.
(1) Preparation of a sulfur-doped three-dimensional network structure conductive polymer/graphene/carbon nanotube composite carbon material
a) An appropriate amount of cetyltrimethylammonium bromide was added into a graphene oxide dispersion with a concentration of 1 mg/ml, and fully dispersed by ultrasonics, then hydrazine hydrate was added, and the product was centrifuged to remove excess surfactant, so as to obtain reduced graphene with micelles formed in the interlayer of graphene.
b) The reduced graphene was dispersed in deionized water, subjected to ultrasonic treatment at 350 W, then added with a pyrrole monomer, continuously subjected to ultrasonics for 60 min, added with ammonium persulfate and hydroxylated aligned multi-walled carbon nanotubes, and stirred in an ice-water bath for 19 h for a polymerization reaction, and the product was centrifuged and then dried under vacuum at 60° C. to obtain a black powder, namely, a polymer/graphene/carbon nanotube composite carbon material with a three-dimensional nano-network structure.
c) The composite carbon material and sodium sulfide were mixed uniformly with a mass ratio of 100:2, reacted at 260° C. in a closed condition with 3.5 MPa pressure for 16 h, cooled naturally, washed 4 times in deionized water, and dried at 85° C. for 7 h, and the obtained product was subjected to a heat treatment at 900° C. for 1 h under a nitrogen atmosphere, so as to obtain the sulfur-doped three-dimensional network structure conductive polymer/graphene/carbon nanotube composite carbon material.

In the steps, a mass ratio of graphene oxide and cetyltrimethylammonium bromide was 1:1.2, a mass ratio of graphene oxide and hydrazine hydrate was 10:7, a mass ratio of the pyrrole monomer and cetyltrimethylammonium bromide was 5:1, and a molar ratio of the pyrrole monomer and ammonium persulfate was 1:1.
(2) Preparation of a composite positive electrode material
d) A sulfur powder and a vanadyl acetylacetonate powder were added into N,N-dimethylformamide (DMF), in which a mass ratio of the sulfur powder and the vanadyl acetylacetonate powder was 0.6:1, and the mixture was subjected to ultrasonics with stirring at 65° C. for 20 h, in which a stirring rate was 500 r/min and a ultrasonic power was 330 W, so as to obtain a mixed solution A with a solid content of 8%.
e) The sulfur-doped three-dimensional network structure conductive polymer/graphene/carbon nanotube composite carbon material obtained in step (1) was added into the mixed solution A, and continuously subjected to ultrasonics with stirring for 1 h, so as to obtain a mixed solution B.
f) The mixed solution B was transferred to a reactor, subjected to a solvothermal reaction at 140° C. for 4.5 h, cooled naturally, then washed in anhydrous ethanol, and fully dried under vacuum at 75° C., so as to obtain the product, and the product was subjected to microwave at 450° C. for 3 h under the protection of an argon atmosphere, so as to obtain the composite positive electrode material.

### Example 5

This example had the same preparation methods and conditions as those in Example 1, except that the hydroxylated aligned multi-walled carbon nanotubes were replaced with disordered hydroxylated multi-walled carbon nanotubes.

### Example 6

This example had the same preparation methods and conditions as those in Example 1, except that the microwave temperature was adjusted to 350° C.

### Comparative Example 1

This comparative example had the same methods and conditions as those in Example 1, except that no carbon nanotube was added.

### Comparative Example 2

This comparative example had the same methods and conditions as those in Example 1, except that no reduced graphene was used.

### Comparative Example 3

This comparative example had the same methods and conditions as those in Example 1, except that no pyrrole monomer or initiator was added.

Electrochemical performance test of composite positive electrode materials

The composite positive electrode material, binder PVDF, and acetylene black were mixed uniformly in a ratio of 80:10:10, prepared into a paste with water, then uniformly coated on a titanium foil, and dried in a vacuum oven at 80° C. for 12 h, so as to obtain a positive electrode. With a zinc foil as a negative electrode, an aqueous solution of zinc sulfate as an electrolyte liquid, and glass fiber separator as a separator, a 2032-type zinc-ion button battery was assembled. In the voltage range of 0.1-0.8 V, and with the current density of 300 mA/g, the initial discharge specific capacity, the discharge specific capacity after 50 cycles and the discharge specific capacity after 150 cycles were tested, and the electrochemical performances of the composite positive electrode materials in the examples and comparative examples are shown in Table 1.

TABLE 1
Electrochemical performances of the composite positive electrode
materials in the corresponding examples and comparative examples

| | | Discharge | | Discharge | |
|---|---|---|---|---|---|
| | | Specific | Capacity | Specific | Capacity |
| | Initial Discharge | Capacity after | Retention Rate | Capacity after | Retention Rate |
| | Specific Capacity | 50 cycles | after 50 cycles | 150 cycles | after 150 cycles |
| Item | (mAh/g) | (mAh/g) | (%) | (mAh/g) | (%) |
| Example 1 | 221 | 219 | 99 | 216 | 97.7 |
| Example 2 | 218 | 214 | 98.2 | 211 | 96.8 |
| Example 3 | 219 | 216 | 98.6 | 212 | 96.8 |
| Example 4 | 217 | 213 | 98.2 | 201 | 92.6 |
| Example 5 | 214 | 210 | 98.1 | 196 | 91.6 |
| Example 6 | 215 | 212 | 98.6 | 201 | 93.5 |
| Comparative | 197 | 190 | 96.4 | 172 | 87.3 |
| Example 1 | | | | | |
| Comparative | 205 | 195 | 95.1 | 188 | 91.7 |
| Example 2 | | | | | |
| Comparative | 206 | 193 | 93.7 | 189 | 91.7 |
| Example 3 | | | | | |

By comparing Example 1 and Example 5, after the hydroxylated aligned multi-walled carbon nanotubes were replaced with the disordered hydroxylated multi-walled carbon nanotubes in Example 5, the initial discharge specific capacity decreased by 3%, and the capacity retention rates after 30 cycles and 150 cycles decreased by 0.9% and 6.1%, respectively; it can be seen that, after replacing the aligned carbon nanotubes with disordered carbon nanotubes, not only the initial discharge specific capacity decreases dramatically, but the capacity retention rate decreases more significantly along with the cycle number increasing; the aligned carbon nanotubes have great significance to the improvement of the electronic conductivity of the composite positive electrode material.

By comparing Example 1 and Example 6, after the microwave temperature was adjusted to 350° C. in Example 6 from 600° C. in Example 1, the initial discharge specific capacity of the composite positive electrode material decreased from 221 mAh/g to 215 mAh/g, and the capacity retention rate decreased by only 0.4% after 30 cycles; however, after 150 cycles, the specific capacities were 216 mAh/g and 201 mAh/g, respectively, and the capacity retention rate decreased by 4.2% from 97.7% to 93.5%. It can be seen that, after reducing the microwave treatment temperature, the organic polymer is not completely pyrolyzed and converted into carbon material, which thus affects the specific capacity and rate capability of the composite positive electrode material.

By comparing Example 1 and Comparative Example 1, in Comparative Example 1 that no carbon nanotube was added, the initial discharge specific capacity of the composite positive electrode material decreased by 8.9% from 221 mAh/g to 197 mAh/g, and the capacity retention rate decreased by only 2.6% after 30 cycles; however, after 150 cycles, the capacity retention rate decreased by 10.4% from 97.7% to 87.3%. It can be seen that, without carbon nanotubes added, the specific capacity and rate capability of the composite positive electrode material are seriously affected, and the aligned carbon nanotubes have a very positive and beneficial effect in improving the electronic conductivity of the composite positive electrode material.

By comparing Example 1 and Comparative Example 2, after no reduced graphene was used during the preparation process of the composite positive electrode material, the initial discharge specific capacity of the composite positive electrode material decreased from 221 mAh/g to 205 mAh/g, and the specific capacity after 150 cycles decreased by 23% from 216 mAh/g to 188 mAh/g. It can be seen that graphene, as a carbon material with good electrical conductivity, plays an important role in improving the specific capacity and rate capability of the composite positive electrode material.

By comparing Example 1 and Comparative Example 3, after no pyrrole monomer or initiator was added during the preparation process of the composite positive electrode material, the initial discharge specific capacity of the composite positive electrode material decreased by 6.8% from 221 mAh/g to 206 mAh/g, the specific capacity after 150 cycles decreased from 206 mAh/g to 187 mAh/g, and the capacity retention rate was 90.8%. It can be seen that, without the introduction of polypyrrole with good electrical conductivity, there will be no carbon formed after polymer pyrolysis in the subsequent microwave heat treatment process, which has a certain adverse effect on improving the specific capacity of the composite positive electrode material; however, the capacity retentions after 30 cycles and 150 cycles were 93.7% and 91.7%, respectively, which does not have a significant effect on the rate capability.

The applicant has stated that although the detailed methods of the present application are described by using the above embodiments in the present application, the present application is not limited to the above detailed methods, which means that the present application does not necessarily rely on the above detailed methods for implementation.

1. A composite positive electrode material, comprising a sulfur-doped three-dimensional network structure conductive polymer/graphene/carbon nanotube composite carbon material, and trivanadium tetrasulfide nanoparticles loaded on a surface of the composite carbon material;
the surface comprises at least one of the outer surface of conductive polymer particles, the surface and the interlayer of graphene sheets, and the outer surface of carbon nanotubes.

2. The composite positive electrode material according to claim 1, wherein the trivanadium tetrasulfide nanoparticles are spherical particles.

3. The composite positive electrode material according to claim 1, wherein a particle size of the trivanadium tetrasulfide nanoparticles is 100-600 nm.

4. The composite positive electrode material according to claim 3, wherein the particle size of the trivanadium tetrasulfide nanoparticles is 200-400 nm.

5. The composite positive electrode material according to claim 1, wherein a mass ratio of the trivanadium tetrasulfide nanoparticles and the composite carbon material is (0.1-30):1, optionally (0.5-25):1, further optionally (0.5-20):1, and especially optionally (1-20):1 excluding 1:1;
optionally, in the composite carbon material, the carbon nanotubes are aligned carbon nanotubes;
optionally, in the composite carbon material, the carbon nanotubes has a length of 150-10 μm and a diameter of less than 15 nm;
optionally, in the composite carbon material, the graphene comprises single-layer graphene and/or multi-layer graphene.

6. A preparation method for the composite positive electrode material according to claim 1, comprising the following steps:
(1) adding a sulfur powder and a vanadyl acetylacetonate powder into N,N-dimethylformamide, and subjecting to ultrasonics with stirring, so as to obtain a mixed solution A;
(2) adding a sulfur-doped three-dimensional network structure conductive polymer/graphene/carbon nanotube composite carbon material into the mixed solution obtained in step (1), and continuously subjecting to ultrasonics with stirring, so as to obtain a mixed solution B;
(3) transferring the mixed solution B into a reactor, and subjecting to a solvothermal reaction at 120-200° C., so as to obtain a hydrothermal product; and
(4) subjecting the hydrothermal product to a microwave treatment at 300-800° C. under the protection of an inert atmosphere, so as to obtain the composite positive electrode material.

7. The method according to claim 6, wherein a mass ratio of the sulfur powder and the vanadyl acetylacetonate powder in step (1) is (0.2-0.8):1;
optionally, a solid content of the mixed solution A in step (1) is 3-15%.

8. The method according to claim 6, wherein a preparation method for the sulfur-doped three-dimensional network structure conductive polymer/graphene/carbon nanotube composite carbon material in step (2) comprises the following steps:
(a) mixing graphene oxide with a surfactant, subjecting to ultrasonic dispersion, then mixing with a reducing agent, and subjecting to a chemical reduction, so as to obtain reduced graphene with micelles formed in the interlayer of graphene;
(b) dispersing the reduced graphene in step (a) in a solvent, subjecting to ultrasonic treatment, adding a conductive polymer monomer, continuously subjecting to ultrasonics, adding an initiator and carbon nanotubes, and subjecting to a polymerization reaction, so as to obtain a composite carbon material; and
(c) mixing the composite carbon material in step (b) with a sulfur source, subjecting to a reaction in a closed condition with 2-5 MPa pressure, and subjecting to a heat treatment under an inert atmosphere to realize in-situ doping, so as to obtain the sulfur-doped three-dimensional network structure conductive polymer/graphene/carbon nanotube composite carbon material.

9. The method according to claim 8, wherein the surfactant in step (a) comprises any one or a mixture of at least two of cetyltrimethylammonium bromide, cetyltrimethylammonium chloride, sodium dodecyl sulfate or sodium dodecylbenzenesulfonate;
optionally, a mass ratio of the graphene oxide and the reducing agent in step (a) is 10:(6-10);
optionally, a mass ratio of the graphene oxide and the surfactant in step (a) is 1:(0.05-1.5),
optionally 1:(0.1-1.2);
optionally, the chemical reduction in step (a) is performed in a water bath at 75-95° C.;
optionally, a power of the ultrasonics in step (a) is 50-600 W;
optionally, the reducing agent in step (a) comprises any one or a combination of two of sodium borohydride or hydrazine hydrate, optionally hydrazine hydrate.

10. The method according to claim 6, wherein, a time for the continuously subjecting to ultrasonics with stirring in step (2) is 0.5-2 h;
optionally, a temperature of the solvothermal reaction in step (3) is 120-200° C.;
optionally, a time of the solvothermal reaction in step (3) is 1-6 h.

11. The method according to claim 6, wherein the method comprises the following steps:
(1) adding a surfactant into a graphene oxide dispersion with a concentration of 1-1.5 mg/ml, fully dispersing the surfactant by ultrasonics, and then adding hydrazine hydrate, wherein the surfactant forms micelles in the interlayer of graphene during the process that graphene oxide is reduced by hydrazine hydrate, and centrifuging the product to remove excess surfactant, so as to obtain reduced graphene with micelles formed in the interlayer of graphene;
(2) dispersing the centrifuged product in step (1) in a solvent, subjecting to ultrasonic treatment, then adding a conductive polymer monomer into the mixture, continuously subjecting to ultrasonics for 30-60 min, adding ammonium persulfate and hydroxylated carbon nanotubes, and stirring in an ice-water bath with a rate of 500-3000 r/min for 18-24 h for a polymerization reaction;
(3) centrifuging the product in step (2) and then drying the product under vacuum at 60-70° C., so as to obtain a polymer/graphene/carbon nanotube composite carbon material with a three-dimensional nano-network structure;
(4) mixing the composite carbon material in step (3) with a sulfur source uniformly, subjecting to a reaction in a closed condition with 2-5 MPa pressure, and subjecting the obtained product to a heat treatment under an inert atmosphere to realize in-situ doping, so as to obtain the sulfur-doped three-dimensional network structure conductive polymer/graphene/carbon nanotube composite carbon material;
(5) adding a sulfur powder and a vanadyl acetylacetonate powder into N,N-dimethylformamide, subjecting to rapid stirring and ultrasonics at 55-80° C. for 8-20 h, so as to obtain a mixed solution A with a solid content of 3-15%;
(6) adding the composite carbon material obtained in step (4) into the mixed solution A, continuously stirring and subjecting to ultrasonics for 0.5-2 h, so as to obtain a mixed solution B;
(7) transferring the mixed solution B into a reactor, subjecting to a solvothermal reaction at 120-200° C. for 1-6 h, cooling naturally, then washing with anhydrous ethanol, and fully drying under vacuum at 50-70° C., so as to obtain a product; and
(8) calcining the product obtained in step (7) at 300-800° C. for 1-6 h under the protection of an inert atmosphere, so as to obtain the composite positive electrode material.

12. A zinc-ion battery positive electrode material, comprising the composite positive electrode material according to claim 1.

13. A zinc-ion battery, comprising the zinc-ion battery positive electrode material according to claim 12;
optionally, the zinc-ion battery is an aqueous or organic rechargeable zinc-ion battery.

14. The method according to claim 6, wherein an average particle size of the sulfur powder in step (1) is 1-50 μm;
optionally, an average particle size of the vanadyl acetylacetonate powder in step (1) is 0.5-30 μm.

15. The method according to claim 6, wherein in step (1), a stirring rate is 500-1000 r/min, a power of the ultrasonics is 50-600 W, and a time is 8-20 h;
optionally, a temperature of the ultrasonics with stirring in step (1) is 55-80° C.

16. The method according to claim 8, wherein the solvent in step (b) comprises any one or a mixture of at least two of ethanol, deionized water, inorganic protonic acid or a chloroform solution of ferric chloride;
optionally, an ultrasonic power in step (b) is 80-500 W;
optionally, a time of the continued ultrasonics in step (b) is 0.5-1 h;
optionally, the initiator in step (b) is ammonium persulfate;
optionally, a molar ratio of the polymer monomer and the surfactant in step (b) is (4-6):1;
optionally, a mass ratio of the polymer monomer and the initiator in step (b) is 1:(1-1.5);
optionally, the polymerization reaction in step (b) is performed in an ice-water bath;
optionally, a stirring is performed during the polymerization reaction in step (b), and a rate of the stirring is 500-3000 r/min;
optionally, a time of the polymerization reaction in step (b) is 18-24 h;
optionally, the carbon nanotubes in step (b) are aligned carbon nanotubes, optionally hydroxylated aligned carbon nanotubes, and further optionally hydroxylated aligned multi-walled carbon nanotubes.

17. The method according to claim 8, wherein the sulfur source in step (c) is selected from any one or a combination of at least two of sodium sulfide, sodium thiosulfate, thiourea, thiol, thiophenol, thioether, disulfide, polysulfide, cyclic sulfide, diallyl sulfide, diallyl thiosulfonate, diallyl trisulfide or diallyl disulfide;
optionally, the sulfur source in step (c) is thiourea, or a combination of thiourea and at least one of thiol, thiophenol, thioether, disulfide, polysulfide, cyclic sulfide, diallyl sulfide, diallyl thiosulfonate, diallyl trisulfide or diallyl disulfide;
optionally, based on a mass of the composite carbon material in step (c) being 100%, a mass percentage of the sulfur source is 0.1-5%, optionally 0.1-3%, and further optionally 0.5-2%;
optionally, a temperature of the reaction in step (c) is 130-280° C., optionally 150-260° C., and further optionally 180-230° C.;
optionally, a time of the reaction in step (c) is 1-24 h, optionally 2-16 h;
optionally, the inert atmosphere in step (c) comprises any one or a combination of the two of an argon atmosphere or a nitrogen atmosphere;
optionally, a temperature of the heat treatment in step (c) is 500-1000° C., optionally 600-950° C., and further optionally 650-900° C.;
optionally, a time of the heat treatment in step (c) is 0.5-12 h, optionally 1-8 h.

18. The method according to claim 8, wherein the preparation method for the sulfur-doped three-dimensional network structure conductive polymer/graphene/carbon nanotube composite carbon material further comprises steps of cooling, washing and drying after the reaction is completed but before the heat treatment;
optionally, the washing adopts deionized water, and a number of times of the washing is selected from 3-5 times;
optionally, the drying is vacuum drying;
optionally, a temperature of the drying is 60-100° C.;
optionally, a time of the drying is 8-20 h, optionally 10-16 h.

19. The method according to claim 6, wherein the method further comprises steps of cooling, washing and drying after the solvothermal reaction but before the microwave treatment;
optionally, the washing is a washing with anhydrous ethanol, and the drying is optionally vacuum drying at 50-70° C.;
optionally, a temperature of the microwave treatment in step (4) is 350-700° C., optionally 400-600° C.;
optionally, a time of the microwave treatment in step (4) is 1-5 h, optionally 1.5-4 h.
